(19) United States
(12) Patent Application Publication
(10) Pub. No.: US 2025/0001296 A1
(43) Pub. Date: Jan. 2, 2025

(54) SYSTEMS AND METHODS FOR CUSTOMIZED CONTEXT-SENSITIVE INTERFACES

(71) Applicant: CodeAlgo, Inc., Kansas City, MO (US)

(72) Inventors: Triumfia Houmbie Fulks, Liberty, MO (US); Sedric Lamont Hibler, Kansas City, MO (US)

(21) Appl. No.: 18/740,198

(22) Filed: Jun. 11, 2024

Related U.S. Application Data
(60) Provisional application No. 63/524,184, filed on Jun. 29, 2023.

(51) Int. Cl. A63F 13/533; A63F 13/67; G06F 40/20; G06F 40/40; G09B 19/00

(52) U.S. Cl. CPC A63F 13/533; G06F 40/20; G06F 40/40; A63F 13/67; G09B 19/0053

(57) ABSTRACT

Systems and techniques for customized context-sensitive interfacing are described. In some examples, a content processing system receives a string of text through a user interface. The user interface is part of a video game. The content processing system receives context associated with the video game. The content processing system analyzes the string of text in light of the context to generate an evaluation of the string of text. The content processing system outputs the evaluation of the string of text in the video game.

### CROSS-REFERENCE TO RELATED APPLICATIONS

This application is a continuation of U.S. Non-Provisional Application No. 63/524,184, filed Jun. 29, 2023, which is hereby incorporated by reference, in its entirety and for all purposes.

### BACKGROUND

### 1. Field

The present technologies are generally related to generation and/or use of customized context-sensitive user interfaces. More specifically, the present teachings relate to generation and/or use of customized context-sensitive user interfaces in video games, for instance using large learning models (LLMs) and/or other generative artificial intelligence (AI) technologies.

### 2. Description of the Related Art

Generative artificial intelligence (AI) refers to AI techniques that are designed to generate content. A large language model (LLM) is a language model including at least one machine learning (ML) model that is trained, using training data, to interpret and/or generate language-based content, and can be considered a type of generative AI system.

### SUMMARY

Systems and techniques for customized context-sensitive interfacing are described. In some examples, a content processing system receives a string of text through a user interface. The user interface is part of a video game. The content processing system receives context associated with the video game. The content processing system analyzes the string of text in light of the context to generate an evaluation of the string of text. The content processing system outputs the evaluation of the string of text in the video game.

In one example, an apparatus for customized context-sensitive interfacing is provided. The apparatus includes at least one memory; and at least one processor coupled to the at least one memory and configured to: receive a string of text through a user interface, wherein the user interface is part of a video game; receive context associated with the video game; analyze the string of text in light of the context to generate an evaluation of the string of text; and output the evaluation of the string of text in the video game.

In another example, a method for customized context-sensitive interfacing is provided. The method includes receiving a string of text through a user interface, wherein the user interface is part of a video game; receiving context associated with the video game; analyzing the string of text in light of the context to generate an evaluation of the string of text; and outputting the evaluation of the string of text in the video game.

In another example, a non-transitory computer-readable medium is provided having stored thereon instructions that, when executed by one or more processors, cause the one or more processors to: receive a string of text through a user interface, wherein the user interface is part of a video game; receive context associated with the video game; analyze the string of text in light of the context to generate an evaluation of the string of text; and output the evaluation of the string of text in the video game.

In another example, an apparatus for customized context-sensitive interfacing is provided. The apparatus includes means for receiving a string of text through a user interface, wherein the user interface is part of a video game; means for receiving context associated with the video game; means for analyzing the string of text in light of the context to generate an evaluation of the string of text; and means for outputting the evaluation of the string of text in the video game.

The foregoing, together with other features and aspects, will become more apparent upon referring to the following specification, claims, and accompanying drawings.

### BRIEF DESCRIPTION OF THE FIGURES

FIG. 1 is a block diagram illustrating an architecture of a context-sensitive complier interpretation system, in accordance with some examples;

FIG. 2 is a conceptual diagram illustrating a user interface for providing a context-sensitive interpreted compiler output based on code for a program, in accordance with some examples;

FIG. 3 is a block diagram illustrating an architecture of a content generation and integration system, in accordance with some examples;

FIG. 4 is a conceptual diagram illustrating a user interface for generating visual content 415 based on a prompt, in accordance with some examples;

FIG. 5 is a conceptual diagram illustrating an in-game user interface in which the visual content generated in FIG. 4 is incorporated into a virtual museum setting, in accordance with some examples;

FIG. 6 is a block diagram illustrating an architecture of a content generation system for context-sensitive tutoring, in accordance with some examples;

FIG. 7 is a conceptual diagram illustrating a user interface for a text-based chat bot for context-sensitive tutoring, in accordance with some examples;

FIG. 8 is a block diagram illustrating training of, use of, and/or updating of one or more large language models in the context of a content processing system, in accordance with some examples;

FIG. 9 is a flow diagram illustrating exemplary operations for a process for customized context-sensitive interfacing, in accordance with some examples; and

FIG. 10 is a block diagram of an exemplary computing device that may be used to implement some aspects of the technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

A machine learning (ML) model is a system that is trained, based on training data, to generate an output in response to receipt of an input. In some cases, the training data includes examples of outputs that are pre-generated for associated inputs. Training the ML models using such training data can add and/or modify weights within the ML model (e.g., weights between neurons or nodes of a neural network), encouraging the trained ML model to generate similar outputs to those in the training data if given similar inputs to the corresponding inputs in the training data. In some cases, under a validation phase of training a trained ML model can continue to be updated (further trained) by providing the model with an input that has a corresponding pre-generated output, allowing the trained ML model to generate its own output based on the input, and then comparing the output generated by the trained ML model to the pre-generated output, for instance strengthening weights if the output generated by the trained ML model was close to the pre-generated output, or weakening or removing weights if the output generated by the trained ML model was far from the pre-generated output. In some cases, a trained ML model can continue to be updated (further trained) as the trained ML model is used, for instance by updating (further training) the trained ML model based on the output content that the trained ML model generated as well as feedback (e.g., from a user, from a reward function or model, or from another system) indicating whether the output content is a good output for the input or a bad output for the input.

A generative artificial intelligence (AI) algorithm is an AI algorithm that is configured to, an can, generate content, such as text, images, videos, 3D models, audio, or combinations thereof. In some examples, generative AI algorithms include trained ML model(s) that are trained to generate such content as the output(s) of the trained ML model(s), for instance based on an input that includes a text prompt, an input image, an input audio clip, an input video clip, an input file, or some combination thereof.

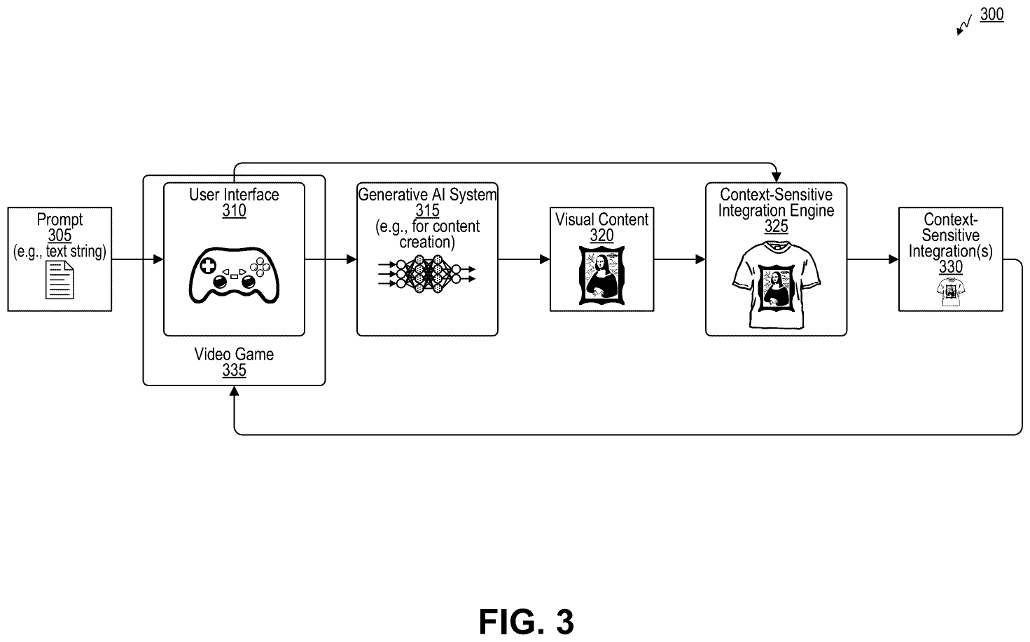

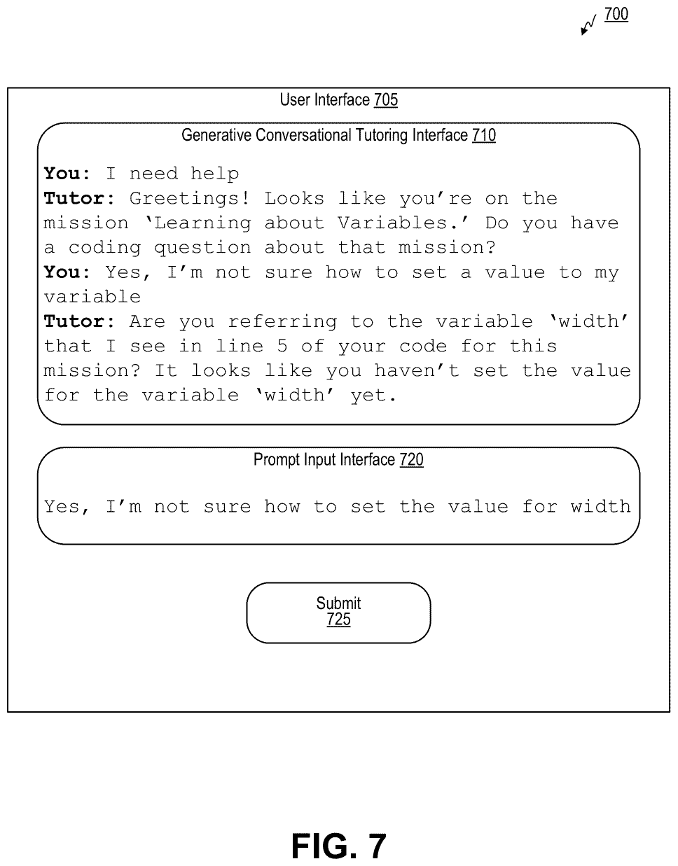

A large language model (LLM) is a language model including at least one machine learning (ML) model that is trained, using training content, to generate content. Training data for LLMs can include, for instance, large quantities of text data, which in some examples may be pre-processed. A content processing system can use an LLM for various tasks, such as predicting next word(s) in a text string based on existing words in the text string (e.g., given to the LLM as a prompt), summarizing content (e.g., the content given to the LLM as a prompt) to generate a summary of the content, analyzing content (e.g., the content given to the LLM as a prompt) to generate an analysis of the content, translating content (e.g., the content given to the LLM as a prompt) from one language to another, generating content requested in a prompt, tutoring (e.g., as illustrated in FIG. 3 and FIG. 7), or a combination thereof. For instance, to train an LLM trained to predict the next word in a text prompt based on training data that includes text data, the LLM can adjust its weights based on the difference between the LLM's prediction for the next word and the actual next word in the training data. This process can repeat numerous times until the LLM becomes sufficiently successful at word prediction. Depending on the task an LLM is configured to perform, the LLM can be trained further for a secondary task (e.g., summarizing content, analyzing content, translating content from one language to another, generating content requested in a prompt, tutoring, or the like) in addition to being trained to predict a next word, allowing the LLM to use its trained ability to predicting words for other purposes.

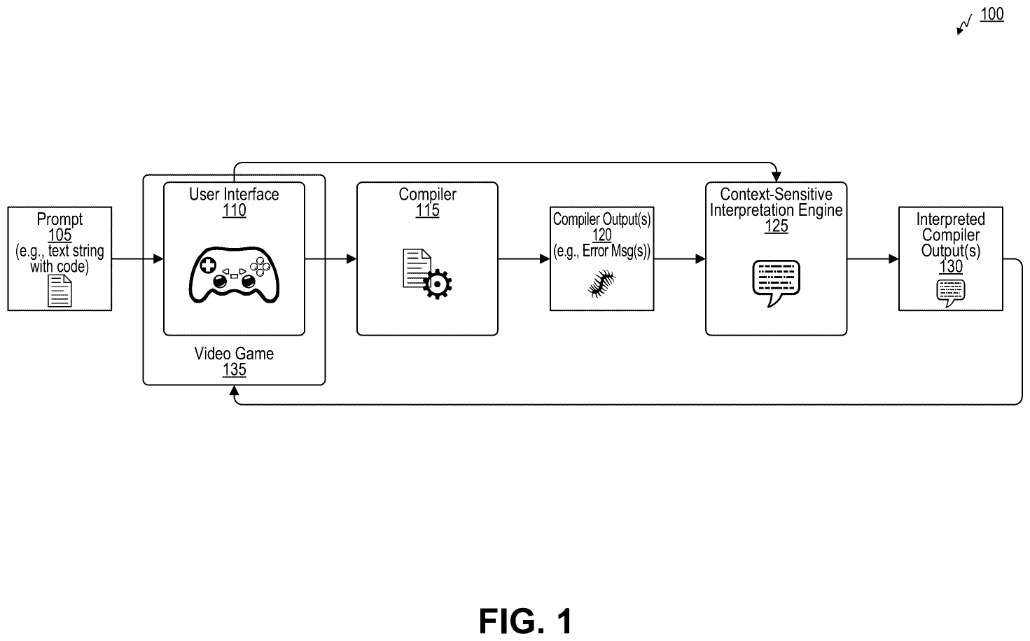

FIG. 1 is a block diagram illustrating an architecture of a context-sensitive complier interpretation system 100. The context-sensitive complier interpretation system 100 receives a prompt 305. The prompt 305 includes a text string, in particular including code for a program, such as source code. In some examples, the code may be in a programming language, such as C, C++, C Sharp, Java, Python, Javascript, PHP, Perl, R, TypeScript, Go, Swift, Assembly, Kotlin, Pascal, Delphi, Ruby, Matlab, Scala, Rust, or a combination thereof. In an illustrative example, the code may be in the Python programming language.

The prompt 305 is received in a user interface 110, which may allow the user to type in, paste in, or otherwise enter in the prompt 305. In some examples, the user interface 110 is a user interface of a video game 135, such as a computer game for a computer, a video game 135 for a video game 135 console, a mobile game for a mobile device, or a combination thereof. In some examples, for instance, the video game 135 may be an educational video game 135 that helps to teach users how to program. In an illustrative example, the educational video game 135 can feature non-player characters (NPCs) that provide missions to a player character controlled by the player. Some of those missions can include programming missions, requesting that the player develop a program to perform a certain task. For instance, tasks associated with different missions can include printing text (e.g., “Hello World!”), developing a calculator, printing a list of Fibonacci numbers, printing a list of prime numbers, printing a multiplication table, concatenating lists, sorting a list, searching through a database, and the like.

The context-sensitive complier interpretation system 100 includes a compiler 115. The compiler 115 is a program that translates program code (e.g., source code) in the prompt 105, which is written in a specific programming language, into machine code, bytecode, assembly code, or another programming language. In some examples, the code in the prompt 105 is written in a human-readable programming language, such as C, C++, Java, or Python. In an illustrative example, the code in the prompt 105 is written in Python. In some examples, the compiler 115 translates the code into a format that is more difficult for humans to read, but more readily executable by a computer. In some examples, the compiler 115 can provide compiler output(s) 120 providing feedback on the code (in the prompt 105) that the compiler 115 is attempting to translate or convert. For instance, if the compiler encounters and recognizes an error in the code, or cannot successfully translate the code due to the error, the compiler can output a warning in the compiler output(s) 120. In some examples, such warnings in the compiler output(s) 120 from the compiler 115 can be cryptic and difficult to read, especially to users who are new to programming.

The context-sensitive complier interpretation system 100 includes a context-sensitive interpretation engine 125. The context-sensitive interpretation engine 125 can interpret the compiler output(s) 120 to generate interpreted compiler output(s) 130 that the context-sensitive interpretation engine 125 can output to the user via the user interface 110. In some examples, the context-sensitive interpretation engine 125 can interpret the compiler output(s) 120 to generate interpreted compiler output(s) 130 that explain what a certain error identified in the compiler output(s) 120 means. In some examples, the context-sensitive interpretation engine 125 can be integrated with the compiler 115. In some examples, the compiler 115 and/or the context-sensitive interpretation engine 125 can use a “catch” command to catch error(s) in the code (that is in the prompt 105), and the context-sensitive interpretation engine 125 can use a “throw” command to output customized interpreted compiler output(s) 130.

For instance, in some examples, if an error identified in the compiler output(s) 120 is a SyntaxError, the context-sensitive interpretation engine 125 can add an explanation to the interpreted compiler output(s) 130 that explains that “This error occurs when you write something that doesn't make sense to the computer, like a misspelled word or a sentence with the wrong order of words.” If an error identified in the compiler output(s) 120 is a IndentationError, the context-sensitive interpretation engine 125 can add an explanation to the interpreted compiler output(s) 130 that explains that “This error happens when you don't correctly indent your code, which is important in Python to show the structure of your program.” If an error identified in the compiler output(s) 120 is a NameError, the context-sensitive interpretation engine 125 can add an explanation to the interpreted compiler output(s) 130 that explains that “This error occurs when you try to use a name that hasn't been defined yet, like if you tried to use a variable that you didn't create.” If an error identified in the compiler output(s) 120 is a TypeError, the context-sensitive interpretation engine 125 can add an explanation to the interpreted compiler output(s) 130 that explains that “This error occurs when you use something in a way that it wasn't meant to be used, like trying to add a number to a string.” If an error identified in the compiler output(s) 120 is a ValueError, the context-sensitive interpretation engine 125 can add an explanation to the interpreted compiler output(s) 130 that explains that “This error happens when you use a value that doesn't make sense in a particular context, like trying to convert the word ‘hello’ into a number.” If an error identified in the compiler output(s) 120 is an IndexError, the context-sensitive interpretation engine 125 can add an explanation to the interpreted compiler output(s) 130 that explains that “This error occurs when you try to access an item in a list or a string that doesn't exist, like trying to get the 10th item in a list that only has 5 items.” If an error identified in the compiler output(s) 120 is a KeyError, the context-sensitive interpretation engine 125 can add an explanation to the interpreted compiler output(s) 130 that explains that “This error happens when you try to access a key in a dictionary that doesn't exist, like trying to get the value for a key that hasn't been defined yet.” If an error identified in the compiler output(s) 120 is a ZeroDivisionError, the context-sensitive interpretation engine 125 can add an explanation to the interpreted compiler output(s) 130 that explains that “This error occurs when you try to divide a number by zero, which is not possible.” If an error identified in the compiler output(s) 120 is a FileNotFoundError, the context-sensitive interpretation engine 125 can add an explanation to the interpreted compiler output(s) 130 that explains that “This error occurs when you try to open or access a file that doesn't exist.” If an error identified in the compiler output(s) 120 is an ImportError, the context-sensitive interpretation engine 125 can add an explanation to the interpreted compiler output(s) 130 that explains that “This error happens when you try to import a module that either doesn't exist or cannot be found by Python.” If an error identified in the compiler output(s) 120 is an AttributeError, the context-sensitive interpretation engine 125 can add an explanation to the interpreted compiler output(s) 130 that explains that “This error occurs when you try to access an attribute or method of an object that doesn't exist or is not available for that object.” If an error identified in the compiler output(s) 120 is an OverflowError, the context-sensitive interpretation engine 125 can add an explanation to the interpreted compiler output(s) 130 that explains that “This error occurs when a calculation produces a number that is too large to be represented within the available memory.” If an error identified in the compiler output(s) 120 is a MemoryError, the context-sensitive interpretation engine 125 can add an explanation to the interpreted compiler output(s) 130 that explains that “This error happens when the program runs out of memory and cannot allocate more memory for its operations.” If an error identified in the compiler output(s) 120 is a RuntimeError, the context-sensitive interpretation engine 125 can add an explanation to the interpreted compiler output(s) 130 that explains that “This error is a generic error that can occur for various reasons during program execution, indicating an abnormal condition.”

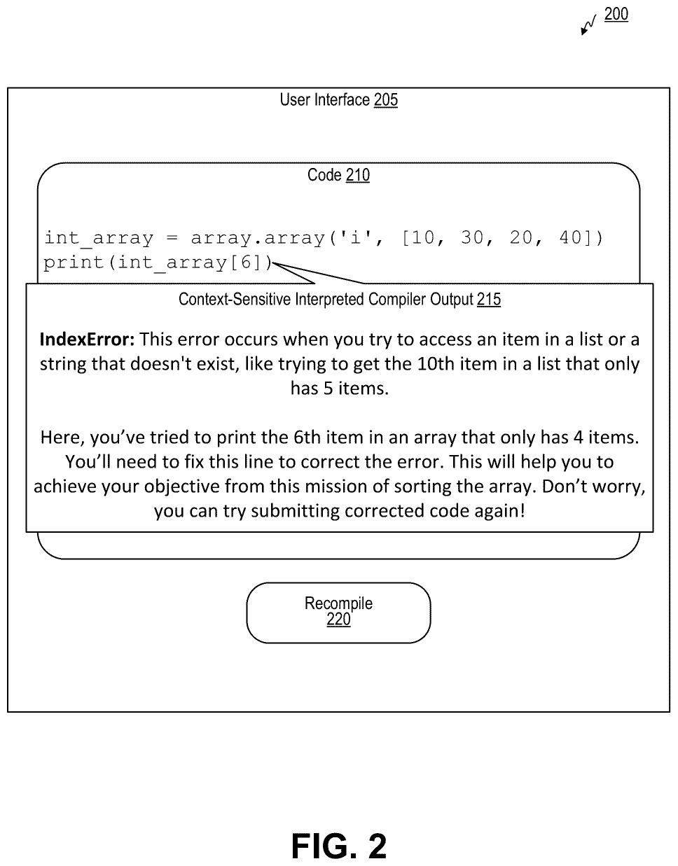

In some examples, the context-sensitive interpretation engine 125 can interpret the compiler output(s) 120 to generate interpreted compiler output(s) 130 that are easier for a user to understand given the level of knowledge and/or understanding of programming than the user has. Thus, for a user who is completely new to programming (which the context-sensitive interpretation engine 125 know based on receiving an indication from the user that the user is new to programming, based on which level or mission the user has reached in the video game 135, and/or based on an assessment of the user's skill level from an analysis of the code that the user produces), the context-sensitive interpretation engine 125 can interpret the compiler output(s) 120 so that the interpreted compiler output(s) 130 are very straightforward to understand, and point directly to the error, as illustrated in FIG. 2. For a user who is more advanced, the context-sensitive interpretation engine 125 can interpret the compiler output(s) 120 so that the interpreted compiler output(s) 130 are more similar to the compiler output(s) 120 themselves, so that the user becomes accustomed to using the compiler 115 without the added layer of the context-sensitive interpretation engine 125 as the user advances in their programming skill.

In some examples, the context-sensitive interpretation engine 125 can also interpret the compiler output(s) 120 in the context of the video game 135 (e.g., in the context of the mission or objective), so that the interpreted compiler output(s) 130 provides feedback to the user that is based on the mission or objective in the video game 135. For instance, the context-sensitive interpretation engine 125 can check which mission the user is on. If the mission the user is on provides an objective of sorting an array, the context-sensitive interpretation engine 125 can analyze the code to identify a variable or set of variables representing the array and can give the user feedback that is specific to what the user did wrong and/or tips that might help the user given the context in the video game 135. For instance, the context-sensitive interpretation engine 125 can analyze the code and identify which line or even set of characters in the code include the error. In some examples, the context-sensitive interpretation engine 125 can analyze the code, and/or generate the interpreted compiler output(s) 130 that provides personalized feedback on code, using a generative AI system, such as a trained ML model and/or a LLM. In some examples, the trained ML model and/or LLM can be trained on training data that includes faulty code with errors, context for a mission objective to be met by the code, as well as helpful messages that provide personalized help in identifying and/or correcting those errors and/or achieving the mission objective with the code. The trained ML model and/or LLM can thus be trained to provide similar personalized help in identifying and/or correcting errors and/or achieving the mission objective, given such code by a player in the video game 135, in some cases given context from the video game 135 as to the mission and/or mission objective. In some examples, the video game 135 can also store a history of past errors that the user has encountered, which can also be fed into the trained ML model and/or LLM, and can allow the context-sensitive interpretation engine 125 to generate interpreted compiler output(s) 130 that take into account errors or mistakes that the user has made in the past to mention that in the interpreted compiler output(s) 130 (e.g., “You seem to have a bit of an issue with forgetting semicolons-perhaps make a note to add them!”).

In some examples, the context-sensitive interpretation engine 125 can also make suggested edits to the code itself. For instance, if the context-sensitive interpretation engine 125 detects a specific error as well as how to fix it (e.g., a missing semicolon), the context-sensitive interpretation engine 125 can suggest the edit, and/or can make the edit directly in the code. In some examples, the interpreted compiler output(s) 130 can include such edits. In some examples, a trained ML model and/or LLM used by the context-sensitive interpretation engine 125 can also be trained to correct errors in code.

FIG. 2 is a conceptual diagram 200 illustrating a user interface 205 for providing a context-sensitive interpreted compiler output 215 based on code 210 for a program. The code 210 is an example of the prompt 105 of FIG. 1. For instance, the code 210 defines an array with four elements (the numbers 10, 30, 20, and 40) and attempts to print the 6th element in the array. The context-sensitive interpreted compiler output 215 is an example of an interpreted computer output 130 generated by the context-sensitive interpretation engine 125 based on compiler output(s) 120. In the user interface 205, the context-sensitive interpreted compiler output 215 identifies an error from the compiler output(s) 120 as being the IndexError, and provides an explanation of the IndexError (“This error occurs when you try to access an item in a list or a string that doesn't exist, like trying to get the 10th item in a list that only has 5 items.”). The context-sensitive interpreted compiler output 215 also points to the specific line of code that attempts to print the 6th element in the array, and includes a personalized and context-sensitive statement stating that “Here, you've tried to print the 6th item in an array that only has 4 items. You'll need to fix this line to correct the error. This will help you to achieve your objective from this mission of sorting the array. Don't worry, you can try submitting corrected code again!” This personalized context-sensitive statement is based on context of the code itself (e.g., by identifying that the array has only 4 elements and that the line of code attempts to access the 6th element in that array) and based on context from the user's mission and/or objective in the video game 135 (e.g., by hinting to the user that correcting this error will help the user achieve their mission objective of sorting the array). The user interface 205 includes a button to recompile 220 that allows the user to recompile the code 210, for instance after the user edits the code 210 based on suggestion(s) provided.

FIG. 3 is a block diagram illustrating an architecture of a content generation and integration system 300. The content generation and integration system 300 receives a prompt 305 through a user interface 310. In some examples, the prompt 305 includes a text string. The user interface 310 may be a user interface associated with a video game 335, as discussed with respect to the user interface 110 and/or the user interface 205. The video game 335 can be an example of the video game 135.

The content generation and integration system 300 includes a generative AI system 315 that is configured to, and can, generate visual content 320 based on the prompt 305. The generative AI system 315 can include one or more trained ML models, and in some cases can include one or more LLMs. For instance, in some examples, the generative AI system 315 can be based on OpenAIR DALL-ER, DALL-E 2®, Stable Diffusion®, Midjourney®, Leonardo®, Adobe® Firefly®, GPT-3 with a graphics API or model, GPT-4 with a graphics API or model, another trained ML model, or a combination thereof. In some examples, the generative AI system 315 can be, or can include, large language models (LLMs) such as a Generative Pre-Trained Transformer (GPT) (e.g., GPT-2, GPT-3, GPT-3.5, GPT-4, etc.), DaVinci, an LLM using LangChain (MIT), or a combination thereof. In some examples, the generative AI system 315 can include one or more neural network(s) (NN(s)), convolutional NN(s) (CNN(s)), trained time delay NN(s) (TDNN(s)), deep network(s), autoencoder(s) (AE(s)), variational AE(s) (VAE(s)), deep belief net(s) (DBN(s)), recurrent NN(s) (RNN(s)), generative adversarial network(s) (GAN(s)), conditional GAN(s) (cGAN(s)), support vector machine(s) (SVM(s)), random forest(s) (RF(s)), decision tree(s), NN(s) with fully connected (FC) layer(s), NN(s) with convolutional layer(s), computer vision (CV) system(s), deep learning (DL) system(s), classifier(s), transformer(s), clustering algorithm(s), gradient boosting model(s), sequence-to-sequence (Seq2Seq) model(s), autoregressive (AR) model(s), large language model(s) (LLMs), model(s) trained using genetic algorithm(s) (GA(s)), model(s) trained using evolutionary algorithm(s) (EA(s)), model(s) trained using neuroevolution of augmenting topologies (NEAT) algorithm(s), model(s) trained using deep Q learning (DQN) algorithm(s), model(s) trained using advantage actor-critic (A2C) algorithm(s), model(s) trained using proximal policy optimization (PPO) algorithm(s), model(s) trained using reinforcement learning (RL) algorithm(s), model(s) trained using supervised learning (SL) algorithm(s), model(s) trained using unsupervised learning (UL) algorithm(s), or combinations thereof. Examples of LLMs that can be used can include, for instance, Generative Pre-Trained Transformer (GPT) (e.g., GPT-2, GPT-3, GPT-3.5, GPT-4, GPT-40, ChatGPT, and/or other GPT variant(s)), DaVinci, LLMs using Massachusetts Institute of Technology (MIT) langchain, Google® Bard®, Google® Gemini®, Large Language Model Meta AI (LLaMA), LLAMA 2, LLAMA 3, LLAMA 4, Megalodon, or combinations thereof.

Within FIG. 3, a graphic representing the generative AI system 315 illustrates a trained ML model (e.g., a neural network) represented as a set of circles connected to another. Each of the circles can represent a node, a neuron, a perceptron, a layer, a portion thereof, or a combination thereof. The circles are arranged in columns. The leftmost column of white circles represent an input layer of the trained ML model. The rightmost column of white circles represent an output layer of the trained ML model. Two columns of shaded circled between the leftmost column of white circles and the rightmost column of white circles each represent hidden layers of the trained ML model. The lines between nodes can represent weights between nodes of the trained ML model. The weights can be modified as the ML model is trained and/or updated, for instance strengthening the weights based on positive feedback to an output to encourage similar outputs given similar inputs, and/or weakening or removing the weights based on negative feedback to an output to discourage similar outputs given similar inputs.

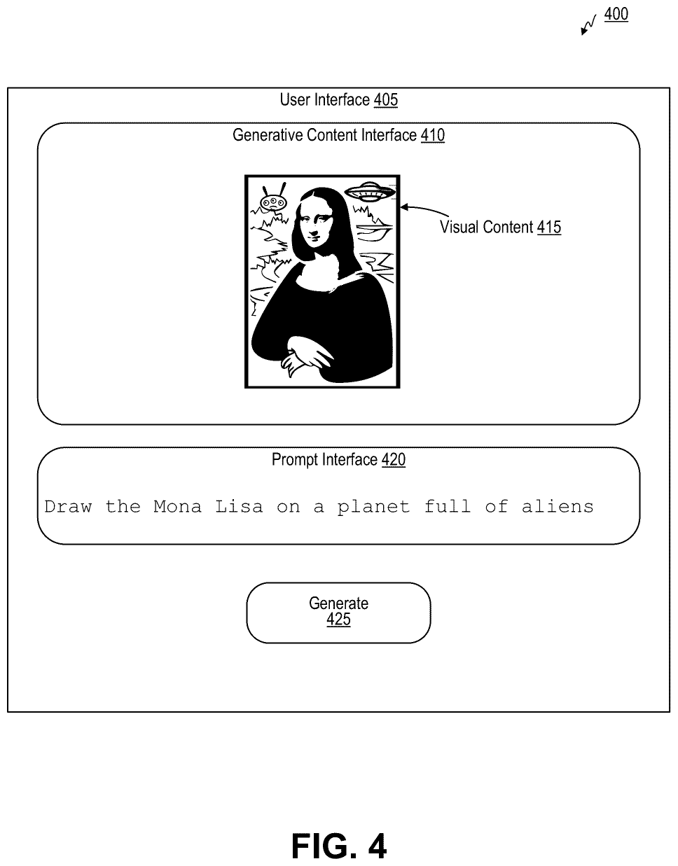

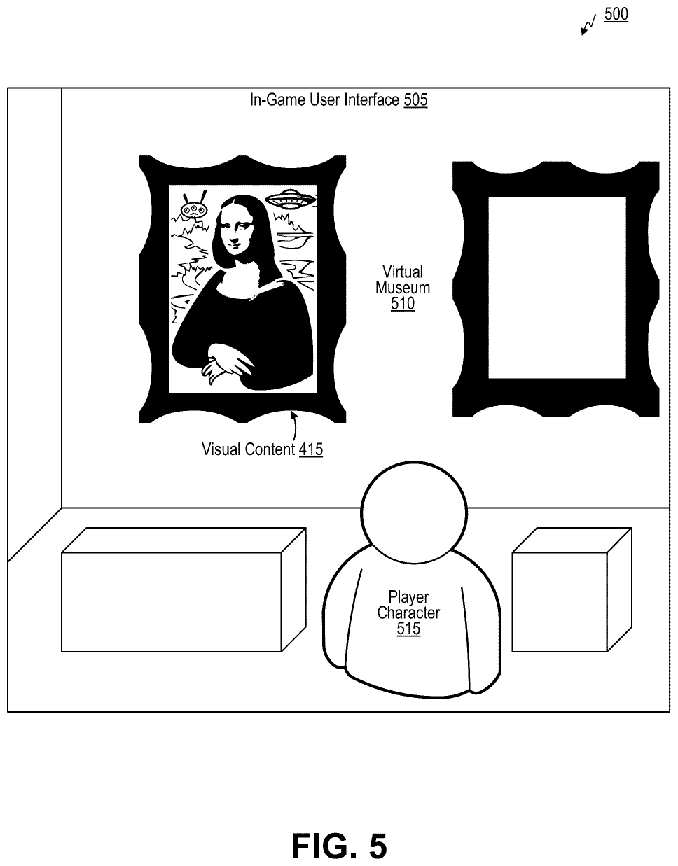

The visual content 320 generated by the generative AI system 315 can include image(s) and/or video(s). An example of the visual content 320 generated by the generative AI system 315 is illustrated in FIG. 3 as a stylized variant of the Mona Lisa with an alien to her left and a flying saucer on her right, as in the visual content 415 of FIGS. 4-5. In some examples, the generative AI system 315 can also context from the video game 335 into account in generating the visual content 320. For instance, in some examples, a mission in the video game 335, or the video game 335 as a whole, may provide part of the prompt 305, and/or may provide additional constraints or requirements for the generative AI system 315. For instance, in some examples, the video game 335 may restrict the generative AI system 315 from generating any visual content 320 that is lewd or explicit, for instance because the video game 335 may be an educational video game that is targeted toward teaching children how to code and/or how to design optimal prompts for generative AI systems. In some examples, a specific mission in the video game 335 may restrict the generative AI system 315 from using certain colors, or may require the generative AI system 315 to use certain colors, as a challenge to the user. In some examples, a specific mission in the video game 335 may provide a portion of a prompt 305 that the user is tasked with completing in a way that makes the generative AI system 315 output visual content 320 that fulfils certain requirements or objectives, as a challenge to the user.

The content generation and integration system 300 includes a context-sensitive integration engine 325 that is configured to, and can, integrate the visual content 320 into the user interface 310 and/or into another aspect of the video game 335, as a set of one or more context-sensitive integrations 330. For instance, the context-sensitive integration(s) 330 can include integrating the visual content 320 as a texture (or as part of a text, or as a basis for at least part of a texture) to be applied to a 3D model in the video game 335. For instance, FIG. 3 includes an illustration of the graphic representing the visual content 320 being used as a texture for a t-shirt to be worn in-game in the video game 335 by a character, such as by a player character controlled by the player, by a second player character controlled by a second player (e.g., if the video game 335 is a multiplayer video game), or by a non-player character (NPC), such as a character who gives the player character missions in the video game. In some examples, one or more of the missions of the video game 335 may involve generating a particular asset of visual content 320, for instance by crafting a prompt 305 that effectively generates the visual content 320 to meet a certain set of requirements or objectives (e.g., depict a person, depict an object, use a specific color, depict a particular type of setting, or a combination thereof).

In some examples, the video game 335 may include an automated scoring system that evaluates how closely the visual content 320 fulfils the objectives. The scoring system can include one or more generative AI systems, trained ML models, and or LLMs as well. For instance, in some examples, the automated scoring system can use object detection to detect whether or not the visual content 320 depicts a person or other type of object, which may for instance be an objective in the mission. In some examples, the automated scoring system can use semantic segmentation detection to detect whether or not the visual content 320 depicts a specific type of material, which may for instance be an objective in the mission. In some examples, the automated scoring system can analyze the colors of different pixels in an image of the visual content 320 to determine if the visual content 320 includes a specific color, which may for instance be an objective in the mission.

In some examples, a compiler (e.g., compiler 115) and/or a context-sensitive interpretation engine (e.g., context-sensitive interpretation engine 125) is associated with one or more NPC(s) in the video game 335, one or more object(s) in the video game 335, one or more player(s) in the video game 335, one or more user interfaces (e.g., user interface 110) in the video game 335, one or more virtual environment(s) (e.g., virtual museum 510) in the video game 335, or a combination thereof. In some examples, the output(s) (e.g., compiler output(s) 120 and/or interpreted compiler output(s) 130) of the compiler 115 and/or the context-sensitive interpretation engine 125 can be customized (e.g., using the generative AI system 315, the generative AI system 615, and/or the LLM(s) 825) so that the output of the compiler 115 and/or the context-sensitive interpretation engine 125 is written from the perspective of, and/or based on attribute(s) of, the NPC(s), the player(s), the object(s), the environment(s), or a combination thereof. For instance, the output(s) (e.g., compiler output(s) 120 and/or interpreted compiler output(s) 130) of the compiler 115 and/or the context-sensitive interpretation engine 125 can be customized based on certain personality traits, writing styles, speaking styles, and/or other contextual information (e.g., context 815) associated with the NPC(s), the player(s), the object(s), the environment(s), or a combination thereof. For instance, output(s) (e.g., compiler output(s) 120 and/or interpreted compiler output(s) 130) of the compiler 115 and/or the context-sensitive interpretation engine 125 can be presented in the video game 335 as being spoken or written by an NPC or player or object (e.g., a computer object in the video game 335), and can have a different style depending on which NPC or player or object is giving the output(s), what environment the output(s) are being given in, or a combination thereof. In an illustrative example, a first NPC (or player or object) might give the output(s) to the player character in a more polite speaking or writing style, while a second NPC (or player or object) might give the output(s) to the player character in a more joking or sarcastic speaking or writing style. Similarly, an NPC (or player or object) might give the output(s) to the player character in a more polite speaking or writing style while the player character and the NPC are in a first in-game environment (e.g., a virtual museum 510, library, school, office, courtroom, or other more formal environment) in the video game 335, and the same NPC (or player or object) might give the output(s) to the player character in a more joking or sarcastic speaking or writing style while the player character and the NPC are in a second in-game environment (e.g., a virtual concert, park, restaurant, or other more casual environment) in the video game 335.

FIG. 4 is a conceptual diagram 400 illustrating a user interface 405 for generating visual content 415 based on a prompt 305. The user interface 405 includes a prompt interface 420 into which a prompt 305 has been entered, reading “Draw the Mona Lisa on a planet full of aliens.” The user interface 405 includes a generative content interface 410 in which visual content 320 generated by the generative AI system 315 in response to a prompt 305 entered into the prompt interface 420 is to be displayed. In the example illustrated in FIG. 4, the generative AI system 315 generates the visual content 415 based on the prompt 305 in the prompt interface 420. The visual content 415 is illustrated in FIG. 4 as depicting a stylized variant of the Mona Lisa painting by Leonardo Da Vinci, with an alien to the left of the Mona Lisa and a flying saucer to the right of the Mona Lisa. The visual content 415 illustrated in FIG. 4 is an example of a type of visual content 320 that can be generated by the generative AI system 315 based on a prompt 305 in the prompt interface 420.

FIG. 5 is a conceptual diagram 500 illustrating an in-game user interface 505 in which the visual content 415 generated in FIG. 4 is incorporated into a virtual museum 510 setting. The in-game user interface 505 can be an example of a screenshot of gameplay of the video game 335, showing the player character 515 moving about through a setting, specifically a virtual museum 510. The 3D model of the virtual museum 510 setting within the video game 335 has been modified by the context-sensitive integration engine 325 to incorporate the visual content 415 (the “Mona Lisa on a planet full of aliens”) as a texture applied to the 3D model of the virtual museum 510, appearing as artwork hanging in the virtual museum 510. This application of the visual content 415 as a texture applied to the 3D model of the virtual museum 510 is an example of a context-sensitive integration 330. In some examples, as mentioned with respect to FIG. 3, the context-sensitive integration engine 325 can modify a 3D model of a character, such as the player character 515, to incorporate the visual content 415 as a texture applied to the 3D model of the character (e.g., the player character 515), for instance appearing as an article of clothing (e.g., a shirt) with the visual content 415 printed on the article of clothing.

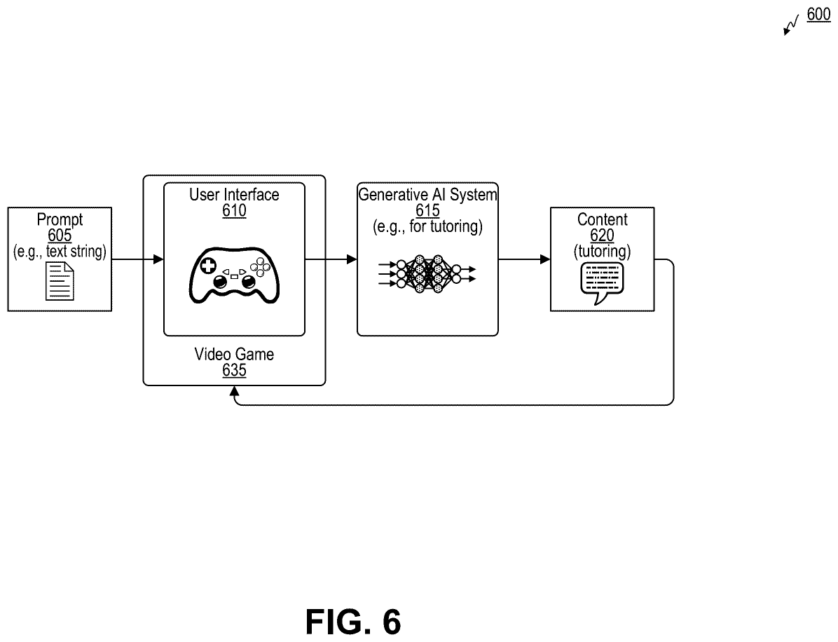

FIG. 6 is a block diagram illustrating an architecture of a content generation system 600 for context-sensitive tutoring. The content generation and integration system 600 receives a prompt 605 through a user interface 610. In some examples, the prompt 605 includes a text string. The user interface 310 may be a user interface associated with a video game 635, as discussed with respect to the user interface 110, the user interface 205, the user interface 310, the user interface 405, and/or the in-game user interface 505. The video game 335 can be an example of the video game 135 and/or the video game 335.

The content generation system 600 includes a generative AI system 615 that is configured to, and can, generate content 620 based on the prompt 605. The content 620 can be generated to be, and/or to include, a string of text, and can be a conversational response to the prompt 605 that conversational responds to the prompt 605 with the purpose of tutoring or teaching the user. For instance, if the prompt 605 asks a question, the generative AI system 615 can generate a response to the question.

The generative AI system 615 can include a trained ML model and/or LLM as discussed with respect to the generative AI system 315. In some examples, the generative AI system 615 can be provided with context from the video game 635 as another input in addition to the prompt 605, and can generate the content 620 based also on the context. For instance, in some examples, the generative AI system 615 can use the prompt 605 and context about the mission that the player is on, and/or the objective(s) of the mission, as an input in generating the content 620. Thus, the content 620 generated by the generative AI system 615 can be context-sensitive and can recognize when the player's prompt 605 refers to a specific detail of the mission and/or objective, for instance. In some examples, the generative AI system 615 can also use a history of previous prompts and/or responses, in addition to the prompt 605 and/or context, in generating the content 620. This provides the generative AI system 615 with a working “memory” to be able to recall and reference previous parts of a conversation. In some examples, the generative AI system 615 can also use other prompts, such as a prompt 105 (with code) and/or a prompt 305 (for generating visual content 320) as an input to the generative AI system 615, for instance so that the generative AI system 615 can know what code the user has entered in as a prompt 105, and/or what prompt 305 the user has requested of the generative AI system 315 for generating the visual content 320, so that the content 320 can reference either or both of these. For instance, the generative AI system 615 can generate the content 620 to be able to review and analyze the user's code from the prompt 105 in light of the user's question in the prompt 605, allowing the content 620 to answer a programming question with specific references to the user's own code. In some examples, the generative AI system 615 also has access, as input(s), to compiler output(s) 120, interpreted compiler output(s) 130, and/or visual content 320, so that the content 620 generated by the generative AI system 615 can reference these. For instance the generative AI system 615 can generate the content 620 to be able to review and analyze the user's code from the prompt 105 in light of the user's question in the prompt 605 and an error message in the compiler output(s) 120, allowing the generative AI system 615 to generate the content 620 to explain the error message in further detail in the specific context of the user's own code from the prompt 105.

FIG. 7 is a conceptual diagram 700 illustrating a user interface 705 for a text-based chat bot for context-sensitive tutoring. The user interface 705 includes a prompt input interface 720 through which a user can input a prompt 605 to the generative AI system 615. The user interface 705 includes a generative conversational tutoring interface 710 through which the user has a conversation with the chat bot tutor. The responses from the chat bot tutor are examples of the content 620 generated by the generative AI system 615.

The user interface 705, as indicated in the generative conversational tutoring interface 710 and the prompt input interface 720, illustrates a conversation between the user and the chat bot tutor that reads as such. The user says “I need help.” In response to this message from the user as a prompt 605, the chat bot tutor (e.g., the generative AI system 615) generates a message (e.g., content 620) stating “Greetings! Looks like you're on the mission ‘Learning about Variables.’ Do you have a coding question about that mission?” The user then says “Yes, I'm not sure how to set a value to my variable.” In response to this message from the user as a prompt 605, the chat bot tutor (e.g., the generative AI system 615) generates a message (e.g., content 620) stating “Are you referring to the variable ‘width’ that I see in line 5 of your code for this mission? It looks like you haven't set the value for the variable ‘width’ yet.” As seen in the prompt input interface 720, the user has typed “Yes, I'm not sure how to set the value for width.” The user interface 705 includes a button to submit 725 the text in the prompt input interface 720 (“Yes, I'm not sure how to set the value for width”) to the chat bot tutor (e.g., the generative AI system 615) as another prompt 605 for which to generate a response (e.g., content 620).

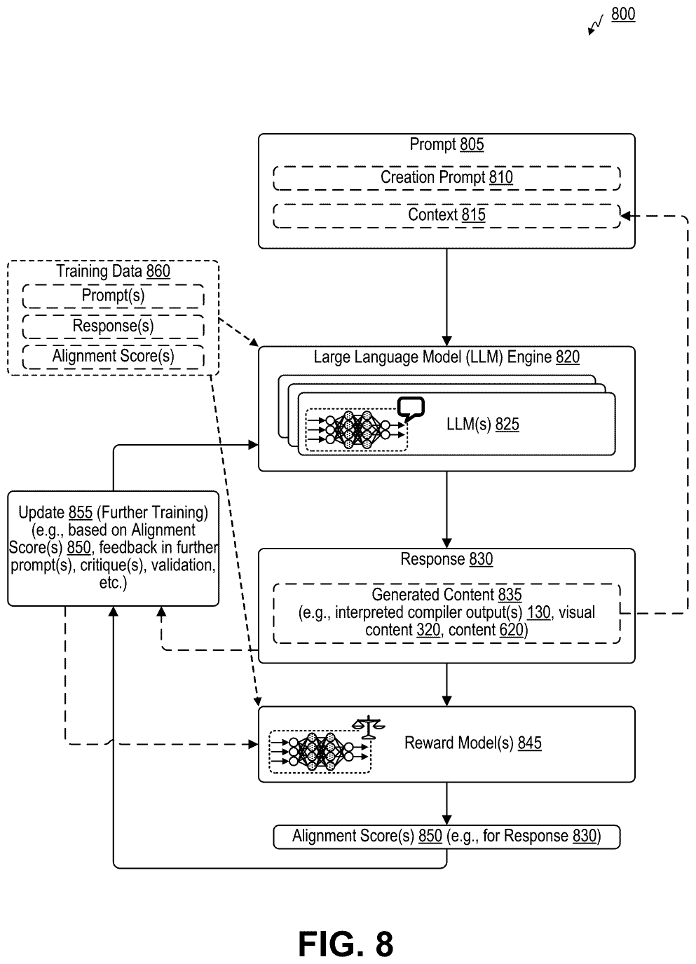

FIG. 8 is a block diagram illustrating training of, use of, and/or updating of one or more large language models 825 in the context of a content processing system 800. The content processing system 800 incudes a LLM engine 820 for training, using, and/or updating one or more LLMs 825. The LLM(s) 825 can include, for example, LLM(s) associated with the context-sensitive interpretation engine 125, the generative AI system 315, the context-sensitive integration engine 325, the generative AI system 615, any other generative AI systems discussed herein, any other trained ML models discussed herein, any other LLMs discussed herein, or a combination thereof.

A prompt 805 (e.g., prompt 105, code 210, prompt 305, the prompt in the prompt interface 420, prompt 605, the prompt in the prompt input interface 720, or another prompt discussed herein) can be passed to the LLM(s) 825 of the LLM engine 820, and input into the LLM(s) 825. In some examples, the prompt 805 includes or identifies content to be analyzed (e.g, as in the context-sensitive interpretation engine 125 analyzing the compiler output(s) 120 and/or the code in the prompt(s) 105 to generate the interpreted compiler output(s) 130) in generated content 835 in response(s) 830. In some examples, the prompt 805 includes a creation prompt 810 specificizing details for generated content 835 to be generated by the LLM(s) 825, for instance specifying rules, configurations, and/or suggestions according to which the generated content 835 is to be created (e.g., as in the generative AI system 315 generating the visual content 320, the generative AI system 615 generating the content 620, and/or the context-sensitive interpretation engine 125 generating the interpreted compiler output(s) 130). In some examples, the prompt 805 includes context 815, for instance context associated with previously generated content (e.g., hence the dashed arrow from the generated content 835 back to context 815), context associated with the video game being played by the user (e.g., the video game 135, the video game 335, the video game 635).

In some examples, the content processing system 800 includes reward model(s) 845 that can analyze the response 830 (e.g., the generated content 835) to determine alignment score(s) 850, for instance indicating how well the generated content 835 aligns with the prompt 805 and/or with expectation(s) of what the LLM(s) 825 should generate based on the prompt 805. For instance, in some examples, the video game may store examples of generated content for various scenarios, which the reward model(s) 845 can compare the generated content 835 to in order to determine the alignment score(s) 850 for the response 830. The LLM engine 820 can use the alignment score(s) 850 to generate an update 855 to update (further train) the LLM(s) 825. The LLM engine 820 can use the update 855 to update (further train) the LLM(s) 825 based on the alignment score(s) 850, based on feedback in further prompts or responses from a user (e.g., received via a user interface such as a prompt input interface 720 of a chat interface such as the generative conversational tutoring interface 710), critique(s), validation (e.g., based on how well the generated content 835 matches up with pre-generated content based on the same prompt or a similar prompt), other feedback, or combinations thereof.

The LLM(s) 825 can have been initially trained by the LLM engine 820 using training data 860 during an initial training phase, before receiving the prompt 805. The training data 860, in some examples, includes examples of prompt(s) (e.g., as in prompt 805), examples of response(s) (e.g., response 830) to the example prompt(s), and/or examples of alignment scores for the example response(s) (e.g., as in the alignment score(s) 850).

In some examples, if alignment score(s) 850 (and/or other feedback) is positive (e.g., expresses, indicates, and/or suggests approval, accuracy, and/or quality), then the ML engine 820 performs the update 855 (further training) of the LLM(s) 825 by updating the LLM(s) 825 to reinforce weights and/or connections within the LLM(s) 825 that contributed to the response(s) 830 that received the positive alignment score(s) 850 or feedback, encouraging the LLM(s) 825 to continue generating similar responses to similar prompts moving forward. In some examples, if alignment score(s) 850 (and/or other feedback) is negative (e.g., expresses, indicates, and/or suggests disapproval, inaccuracy, errors, mistakes, omissions, bugs, crashes, and/or lack of quality), then the ML engine 820 performs the update 855 (further training) of the LLM(s) 825 by updating the LLM(s) 825 to weaken, remove, and/or replace weights and/or connections within the LLM(s) 825 that contributed to the response(s) 830 that received the negative alignment score(s) 850 or feedback, discouraging the LLM(s) 825 from generating similar responses to similar prompts moving forward.

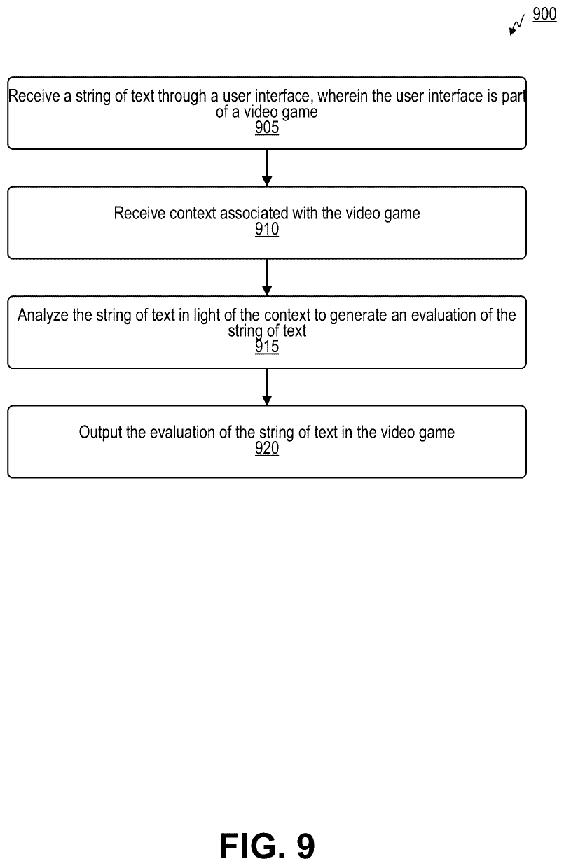

FIG. 9 is a flow diagram illustrating exemplary operations for a process 900 for customized context-sensitive interfacing. The process 900 may be referred to as a method for customized context-sensitive interfacing. The process 900 may be performed by a content processing system. In some examples, the content processing system can include, for instance, the context-sensitive complier interpretation system 100, the user interface 110, the compiler 115, the context-sensitive interpretation engine 125, the video game 135, the user interface 205, the content generation and integration system 300, the user interface 310, the generative AI system 315, the context-sensitive integration engine 325, the video game 335, the user interface 405, the in-game user interface 505, the content generation system 600, the generative AI system 615, the user interface 705, the LLM engine 820, the LLM(s) 825, the reward model(s) 845, the computing system 1000, the processor 1010, an apparatus for content editing, an apparatus for content processing, a system for content editing, a system for content processing, a non-transitory computer-readable storage medium storing instructions that perform the process 900 when executed by a processor such as the processor 1010, other components described herein, substitutes for any of these components, sub-components of any of these components, or a combination thereof.

At operation 905, the content processing system is configured to, and can, receive a string of text through a user interface, wherein the user interface is part of a video game. Examples of the string of text include the prompt 105, the code 210, the prompt 305, the prompt in the prompt interface 420, prompt 605, the prompt in the prompt input interface 720, the prompt 805, the creation prompt 810, another prompt discussed herein, or a combination thereof. Examples of the video game include the video game 135, the video game 335, and/or the video game 635. Examples of the user interface include the user interface 110, the user interface 205, the user interface 310, the user interface 405, the in-game user interface 505, the user interface 610, and/or the user interface 705.

At operation 910, the content processing system is configured to, and can, receive context (e.g., context 815) associated with the video game.

At operation 915, the content processing system is configured to, and can, analyze the string of text in light of the context to generate an evaluation of the string of text. At operation 920, the content processing system is configured to, and can, output the evaluation of the string of text in the video game. Examples of system(s) that perform this analysis and/or generate the evaluation include the context-sensitive interpretation engine 125, the generative AI system 315, the context-sensitive integration engine 325, the generative AI system 615, the LLM(s) 825, or a combination thereof. Examples of the evaluation include interpreted compiler output(s) 130, the context-sensitive interpreted compiler output 215, the virtual content 320, the context-sensitive integration(s) 330, the virtual content 415, the integration of the virtual content 415 into the virtual museum 510, the content 620, the responses from the chat bot tutor in the generative conversational tutoring interface 710 of the user interface 705, the response 830, the generated content 835, or a combination thereof.

In some aspects, the content processing system is configured to, and can, provide at least the string of text to a trained machine learning (ML) model to analyze the string of text in light of the context. In some aspects, the content processing system is configured to, and can, provide the context in addition to the string of text to the trained ML model to analyze the string of text in light of the context. Examples of the trained ML model include the context-sensitive interpretation engine 125, the generative AI system 315, the context-sensitive integration engine 325, the generative AI system 615, the LLM(s) 825, or a combination thereof. In some aspects, the trained ML model is a large language model (LLM).

In some aspects, the evaluation of the string of text includes tutoring (e.g., as in FIG. 6 and/or FIG. 7) based on the string of text and/or the context. In some aspects, the string of text includes code for a program (e.g., code 210), and the evaluation of the string of text includes a modified variant of the code (e.g., the code 210 with a correction or optimization made). In some aspects, the string of text includes code for a program (e.g., code 210), and the evaluation of the string of text identifies an error in the code (e.g., identifies error(s) from compiler output(s) 120 as in the interpreted compiler output(s) 130 and/or the context-sensitive interpreted compiler output 215).

In some aspects, the evaluation of the string of text includes the image (e.g., visual content 320, visual content 415) that is generated by the trained ML model based on at least the string of text and/or the context, and the content processing system is configured to, and can, incorporate an image as a texture in the video game to output the evaluation of the string of text in the video game (e.g., as in the incorporation of the visual content 415 in the virtual museum 510 or on a shirt or other article of clothing for a character such as the player character 515).

In some aspects, the content processing system is configured to, and can, compile code in the string of text using a compiler (e.g., compiler 115) to analyze the string of text in light of the context. The content processing system can receive a compiler output (e.g., compiler output(s) 120) from the compiler. The evaluation of the string of text can be based on the compiler output (e.g., can include interpreted compiler output(s) 130 such as the context-sensitive interpreted compiler output 215, and/or can include the compiler output(s) 120). In some aspects, the content processing system is configured to, and can, interpret the compiler output from the compiler based on a level of skill of a player of the video game to generate an interpretation of the compiler output (e.g., interpreted compiler output(s) 130 such as the context-sensitive interpreted compiler output 215), with the evaluation including the interpretation of the compiler output. In some aspects, the compiler output identifies at least one error in the code, and the interpretation of the compiler output explains the at least one error in the context of the code and the video game.

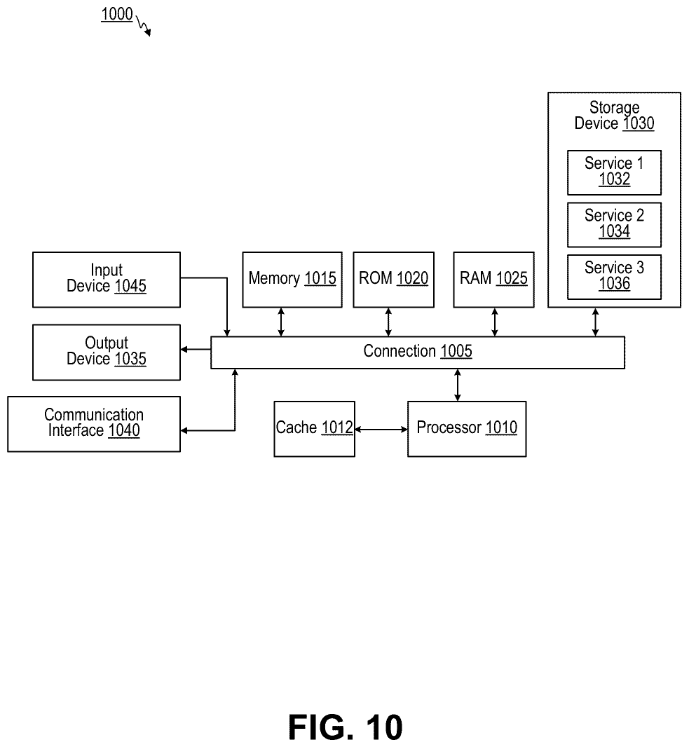

FIG. 10 illustrates an exemplary computing system 1000 that may be used to implement some aspects of the technology. For example, any of the computing devices, computing systems, network devices, network systems, servers, and/or arrangements of circuitry described herein may include at least one computing system 1000, or may include at least one component of the computer system 1000 identified in FIG. 10. The computing system 1000 of FIG. 10 includes one or more processors 1010 and memory units 1020. Each of the processor(s) 1010 may refer to one or more processors, controllers, microcontrollers, central processing units (CPUs), graphics processing units (GPUs), arithmetic logic units (ALUs), accelerated processing units (APUs), digital signal processors (DSPs), application specific integrated circuits (ASICs), field-programmable gate arrays (FPGAs), or combinations thereof. Each of the processor(s) 1010 may include one or more cores, either integrated onto a single chip or spread across multiple chips connected or coupled together. Memory 1020 stores, in part, instructions and data for execution by processor 1010. Memory 1020 can store the executable code when in operation. The system 1000 of FIG. 10 further includes a mass storage device 1030, portable storage medium drive(s) 1040, output devices 1050, user input devices 1060, a display system 1070 (e.g., a graphics display), and peripheral devices 1080.

The components shown in FIG. 10 are depicted as being connected via a single bus 1090. However, the components may be connected through one or more data transport means. For example, processor unit 1010 and memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 can store the system software for implementing some aspects of the subject technology for purposes of loading that software into memory 1020.

Portable storage device 1040 operates in conjunction with a portable non-volatile storage medium, such as a floppy disk, compact disk or Digital video disc, to input and output data and code to and from the computer system 1000 of FIG. 10. The system software for implementing aspects of the subject technology may be stored on such a portable medium and input to the computer system 1000 via the portable storage device 1040.

The memory 1020, mass storage device 1030, or portable storage 1040 may in some cases store sensitive information, such as transaction information, health information, or cryptographic keys, and may in some cases encrypt or decrypt such information with the aid of the processor 1010. The memory 1020, mass storage device 1030, or portable storage 1040 may in some cases store, at least in part, instructions, executable code, or other data for execution or processing by the processor 1010.

Output devices 1050 may include, for example, communication circuitry for outputting data through wired or wireless means, display circuitry for displaying data via a display screen, audio circuitry for outputting audio via headphones or a speaker, printer circuitry for printing data via a printer, or some combination thereof. The display screen may be any type of display discussed with respect to the display system 1070. The printer may be inkjet, laserjet, thermal, or some combination thereof. In some cases, the output device circuitry 1050 may allow for transmission of data over an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. Output devices 1050 may include any ports, plugs, antennae, wired or wireless transmitters, wired or wireless transceivers, or any other components necessary for or usable to implement the communication types listed above, such as cellular Subscriber Identity Module (SIM) cards.

Input devices 1060 may include circuitry providing a portion of a user interface. Input devices 1060 may include an alpha-numeric keypad, such as a keyboard, for inputting alpha-numeric and other information, or a pointing device, such as a mouse, a trackball, stylus, or cursor direction keys. Input devices 1060 may include touch-sensitive surfaces as well, either integrated with a display as in a touchscreen, or separate from a display as in a trackpad. Touch-sensitive surfaces may in some cases detect localized variable pressure or force detection. In some cases, the input device circuitry may allow for receipt of data over an audio jack, a microphone jack, a universal serial bus (USB) port/plug, an Apple® Lightning® port/plug, an Ethernet port/plug, a fiber optic port/plug, a proprietary wired port/plug, a wired local area network (LAN) port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, personal area network (PAN) signal transfer, wide area network (WAN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. Input devices 1060 may include any ports, plugs, antennae, wired or wireless receivers, wired or wireless transceivers, or any other components necessary for or usable to implement the communication types listed above, such as cellular SIM cards.

Input devices 1060 may include receivers or transceivers used for positioning of the computing system 1000 as well. These may include any of the wired or wireless signal receivers or transceivers. For example, a location of the computing system 1000 can be determined based on signal strength of signals as received at the computing system 1000 from three cellular network towers, a process known as cellular triangulation. Fewer than three cellular network towers can also be used-even one can be used-though the location determined from such data will be less precise (e.g., somewhere within a particular circle for one tower, somewhere along a line or within a relatively small area for two towers) than via triangulation. More than three cellular network towers can also be used, further enhancing the location's accuracy. Similar positioning operations can be performed using proximity beacons, which might use short-range wireless signals such as BLUETOOTH® wireless signals, BLUETOOTH® low energy (BLE) wireless signals, IBEACON® wireless signals, personal area network (PAN) signals, microwave signals, radio wave signals, or other signals discussed above. Similar positioning operations can be performed using wired local area networks (LAN) or wireless local area networks (WLAN) where locations are known of one or more network devices in communication with the computing system 1000 such as a router, modem, switch, hub, bridge, gateway, or repeater. These may also include Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. Input devices 1060 may include receivers or transceivers corresponding to one or more of these GNSS systems.

Display system 1070 may include a liquid crystal display (LCD), a plasma display, an organic light-emitting diode (OLED) display, a low-temperature poly-silicon (LTPO) display, an electronic ink or “e-paper” display, a projector-based display, a holographic display, or another suitable display device. Display system 1070 receives textual and graphical information, and processes the information for output to the display device. The display system 1070 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 1080 may include any type of computer support device to add additional functionality to the computer system. For example, peripheral device(s) 1080 may include one or more additional output devices of any of the types discussed with respect to output device 1050, one or more additional input devices of any of the types discussed with respect to input device 1060, one or more additional display systems of any of the types discussed with respect to display system 1070, one or more memories or mass storage devices or portable storage devices of any of the types discussed with respect to memory 1020 or mass storage 1030 or portable storage 1040, a modem, a router, an antenna, a wired or wireless transceiver, a printer, a bar code scanner, a quick-response (“QR”) code scanner, a magnetic stripe card reader, a integrated circuit chip (ICC) card reader such as a smartcard reader or a EUROPAY®-MASTERCARD®-VISA® (EMV) chip card reader, a near field communication (NFC) reader, a document/image scanner, a visible light camera, a thermal/infrared camera, an ultraviolet-sensitive camera, a night vision camera, a light sensor, a phototransistor, a photoresistor, a thermometer, a thermistor, a battery, a power source, a proximity sensor, a laser rangefinder, a sonar transceiver, a radar transceiver, a lidar transceiver, a network device, a motor, an actuator, a pump, a conveyer belt, a robotic arm, a rotor, a drill, a chemical assay device, or some combination thereof.

The components contained in the computer system 1000 of FIG. 10 can include those typically found in computer systems that may be suitable for use with some aspects of the subject technology and represent a broad category of such computer components that are well known in the art. That said, the computer system 1000 of FIG. 10 can be customized and specialized for the purposes discussed herein and to carry out the various operations discussed herein, with specialized hardware components, specialized arrangements of hardware components, and/or specialized software. Thus, the computer system 1000 of FIG. 10 can be a personal computer, a hand held computing device, a telephone (“smartphone” or otherwise), a mobile computing device, a workstation, a server (on a server rack or otherwise), a minicomputer, a mainframe computer, a tablet computing device, a wearable device (such as a watch, a ring, a pair of glasses, or another type of jewelry or clothing or accessory), a video game console (portable or otherwise), an e-book reader, a media player device (portable or otherwise), a vehicle-based computer, another type of computing device, or some combination thereof. The computer system 1000 may in some cases be a virtual computer system executed by another computer system. The computer can also include different bus configurations, networked platforms, multi-processor platforms, etc. Various operating systems can be used including Unix®, Linux®, FreeBSD®, FreeNAS®, pfSense®, Windows®, Apple® Macintosh OS® (“MacOS®”), Palm OS®, Google® Android®, Google® Chrome OS®, Chromium® OS®, OPENSTEP®, XNUR, Darwin®, Apple® iOS®, Apple® tvOS®, Apple® watchOS®, Apple® audioOS®, Amazon® Fire OS®, Amazon® Kindle OS®, variants of any of these, other suitable operating systems, or combinations thereof. The computer system 1000 may also use a Basic Input/Output System (BIOS) or Unified Extensible Firmware Interface (UEFI) as a layer upon which the operating system(s) are run.

In some cases, the computer system 1000 may be part of a multi-computer system that uses multiple computer systems 1000, each for one or more specific tasks or purposes. For example, the multi-computer system may include multiple computer systems 1000 communicatively coupled together via at least one of a personal area network (PAN), a local area network (LAN), a wireless local area network (WLAN), a municipal area network (MAN), a wide area network (WAN), or some combination thereof. The multi-computer system may further include multiple computer systems 1000 from different networks communicatively coupled together via the internet (also known as a “distributed” system).

Some aspects of the subject technology may be implemented in an application that may be operable using a variety of devices. Non-transitory computer-readable storage media refer to any medium or media that participate in providing instructions to a central processing unit (CPU) for execution and that may be used in the memory 1020, the mass storage 1030, the portable storage 1040, or some combination thereof. Such media can take many forms, including, but not limited to, non-volatile and volatile media such as optical or magnetic disks and dynamic memory, respectively. Some forms of non-transitory computer-readable media include, for example, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L15), resistive random-access memory (RRAM/ReRAM), phase change memory (PCM), spin transfer torque RAM (STT-RAM), another memory chip or cartridge, or a combination thereof.

Various forms of transmission media may be involved in carrying one or more sequences of one or more instructions to a processor 1010 for execution. A bus 1090 carries the data to system RAM or another memory 1020, from which a processor 1010 retrieves and executes the instructions. The instructions received by system RAM or another memory 1020 can optionally be stored on a fixed disk (mass storage device 1030/portable storage 1040) either before or after execution by processor 1010. Various forms of storage may likewise be implemented as well as the necessary network interfaces and network topologies to implement the same.

While various flow diagrams provided and described above may show a particular order of operations performed by some embodiments of the subject technology, it should be understood that such order is exemplary. Alternative embodiments may perform the operations in a different order, combine certain operations, overlap certain operations, or some combination thereof. It should be understood that unless disclosed otherwise, any process illustrated in any flow diagram herein or otherwise illustrated or described herein may be performed by a machine, mechanism, and/or computing system 1000 discussed herein, and may be performed automatically (e.g., in response to one or more triggers/conditions described herein), autonomously, semi-autonomously (e.g., based on received instructions), or a combination thereof. Furthermore, any action described herein as occurring in response to one or more particular triggers/conditions should be understood to optionally occur automatically response to the one or more particular triggers/conditions.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claims.

Illustrative aspects of the disclosure include:

Aspect 1. An apparatus for content editing, the apparatus comprising: at least one memory; and at least one processor coupled to the at least one memory and configured to: receive a string of text through a user interface, wherein the user interface is part of a video game; receive context associated with the video game; analyze the string of text in light of the context to generate an evaluation of the string of text; and output the evaluation of the string of text in the video game.

Aspect 2. The apparatus of Aspect 1, the at least one processor to: provide at least the string of text to a trained machine learning (ML) model to analyze the string of text in light of the context.

Aspect 3. The apparatus of Aspect 2, the at least one processor to: provide the context in addition to the string of text to the trained ML model to analyze the string of text in light of the context.

Aspect 4. The apparatus of any of Aspects 2 to 3, wherein the trained ML model is a large language model (LLM).

Aspect 5. The apparatus of any of Aspects 2 to 4, wherein the evaluation of the string of text includes tutoring based on at least one of the string of text or the context.

Aspect 6. The apparatus of any of Aspects 2 to 5, wherein the string of text includes code for a program, and wherein the evaluation of the string of text includes a modified variant of the code.

Aspect 7. The apparatus of any of Aspects 2 to 6, wherein the string of text includes code for a program, and wherein the evaluation of the string of text identifies an error in the code.

Aspect 8. The apparatus of any of Aspects 2 to 7, the at least one processor to: incorporate an image as a texture in the video game to output the evaluation of the string of text in the video game, wherein the evaluation of the string of text includes the image, wherein the image is generated by the trained ML model based on at least the string of text.

Aspect 9. The apparatus of any of Aspects 2 to 8, the at least one processor to: incorporate an image as a texture in the video game to output the evaluation of the string of text in the video game, wherein the evaluation of the string of text includes the image, wherein the image is generated by the trained ML model based on at least the string of text and the context.

Aspect 10. The apparatus of any of Aspects 1 to 9, the at least one processor to: compile code in the string of text using a compiler to analyze the string of text in light of the context; and receive a compiler output from the compiler, wherein the evaluation of the string of text is based on the compiler output.

Aspect 11. The apparatus of Aspect 10, the at least one processor to: interpret the compiler output from the compiler based on a level of skill of a player of the video game to generate an interpretation of the compiler output, wherein the evaluation includes the interpretation of the compiler output.

Aspect 12. The apparatus of Aspect 11, wherein the compiler output identifies at least one error in the code, and wherein the interpretation of the compiler output explains the at least one error in the context of the code and the video game.

Aspect 13. A method for content editing, the method comprising: receiving a string of text through a user interface, wherein the user interface is part of a video game; receiving context associated with the video game; analyzing the string of text in light of the context to generate an evaluation of the string of text; and outputting the evaluation of the string of text in the video game.

Aspect 14. The method of Aspect 13, further comprising: providing at least the string of text to a trained machine learning (ML) model to analyze the string of text in light of the context.

Aspect 15. The method of Aspect 14, further comprising: providing the context in addition to the string of text to the trained ML model to analyze the string of text in light of the context.

Aspect 16. The method of any of Aspects 14 to 15, wherein the trained ML model is a large language model (LLM).

Aspect 17. The method of any of Aspects 14 to 16, wherein the evaluation of the string of text includes tutoring based on at least one of the string of text or the context.

Aspect 18. The method of any of Aspects 14 to 17, wherein the string of text includes code for a program, and wherein the evaluation of the string of text includes a modified variant of the code.

Aspect 19. The method of any of Aspects 14 to 18, wherein the string of text includes code for a program, and wherein the evaluation of the string of text identifies an error in the code.

Aspect 20. The method of any of Aspects 14 to 19, further comprising: incorporating an image as a texture in the video game to output the evaluation of the string of text in the video game, wherein the evaluation of the string of text includes the image, wherein the image is generated by the trained ML model based on at least the string of text.

Aspect 21. The method of any of Aspects 14 to 20, further comprising: incorporating an image as a texture in the video game to output the evaluation of the string of text in the video game, wherein the evaluation of the string of text includes the image, wherein the image is generated by the trained ML model based on at least the string of text and the context.

Aspect 22. The method of any of Aspects 13 to 21, further comprising: compiling code in the string of text using a compiler to analyze the string of text in light of the context; and receiving a compiler output from the compiler, wherein the evaluation of the string of text is based on the compiler output.

Aspect 23. The method of Aspect 22, the at least one processor to: interpret the compiler output from the compiler based on a level of skill of a player of the video game to generate an interpretation of the compiler output, wherein the evaluation includes the interpretation of the compiler output.

Aspect 24. The method of Aspect 23, wherein the compiler output identifies at least one error in the code, and wherein the interpretation of the compiler output explains the at least one error in the context of the code and the video game.

Aspect 25. A non-transitory computer-readable medium having stored thereon instructions that, when executed by one or more processors, cause the one or more processors to perform operations according to any of Aspects 1 to 24.

Aspect 26: An apparatus comprising means for performing operations according to any of Aspects 1 to 24.

What is claimed is:

1. An apparatus for customized context-sensitive interfacing, the apparatus comprising:
at least one memory; and
at least one processor coupled to the at least one memory, the at least one processor executing instructions stored in the at least one memory to:
receive a string of text through a user interface, wherein the user interface is part of a video game;
receive context associated with the video game;
analyze the string of text in light of the context to generate an evaluation of the string of text; and
output the evaluation of the string of text in the video game.

2. The apparatus of claim 1, the at least one processor to:
provide at least the string of text to a trained machine learning (ML) model to analyze the string of text in light of the context.

3. The apparatus of claim 2, the at least one processor to:
provide the context in addition to the string of text to the trained ML model to analyze the string of text in light of the context.

4. The apparatus of claim 2, wherein the trained ML model is a large language model (LLM).

5. The apparatus of claim 2, wherein the evaluation of the string of text includes tutoring based on at least one of the string of text or the context.

6. The apparatus of claim 2, wherein the string of text includes code for a program, and wherein the evaluation of the string of text includes a modified variant of the code.

7. The apparatus of claim 2, wherein the string of text includes code for a program, and wherein the evaluation of the string of text identifies an error in the code.

8. The apparatus of claim 2, the at least one processor to:
incorporate an image as a texture in the video game to output the evaluation of the string of text in the video game, wherein the evaluation of the string of text includes the image, wherein the image is generated by the trained ML model based on at least the string of text.

9. The apparatus of claim 2, the at least one processor to:
incorporate an image as a texture in the video game to output the evaluation of the string of text in the video game, wherein the evaluation of the string of text includes the image, wherein the image is generated by the trained ML model based on at least the string of text and the context.

10. The apparatus of claim 1, the at least one processor to:
compile code in the string of text using a compiler to analyze the string of text in light of the context; and
receive a compiler output from the compiler, wherein the evaluation of the string of text is based on the compiler output.

11. The apparatus of claim 10, the at least one processor to:
interpret the compiler output from the compiler based on a level of skill of a player of the video game to generate an interpretation of the compiler output, wherein the evaluation includes the interpretation of the compiler output.

12. The apparatus of claim 11, wherein the compiler output identifies at least one error in the code, and wherein the interpretation of the compiler output explains the at least one error in the context of the code and the video game.

13. A method for content editing, the method comprising:
receiving a string of text through a user interface, wherein the user interface is part of a video game;
receiving context associated with the video game;
analyzing the string of text in light of the context to generate an evaluation of the string of text; and
outputting the evaluation of the string of text in the video game.

14. The method of claim 13, further comprising:
providing at least the string of text to a trained machine learning (ML) model to analyze the string of text in light of the context.

15. The method of claim 14, further comprising:
providing the context in addition to the string of text to the trained ML model to analyze the string of text in light of the context.

16. The method of claim 14, wherein the string of text includes code for a program, and wherein the evaluation of the string of text includes at least one of a modified variant of the code or an error in the code.

17. The method of claim 14, further comprising:
incorporating an image as a texture in the video game to output the evaluation of the string of text in the video game, wherein the evaluation of the string of text includes the image, wherein the image is generated by the trained ML model based on at least the string of text.

18. The method of claim 13, further comprising:
compiling code in the string of text using a compiler to analyze the string of text in light of the context; and
receiving a compiler output from the compiler, wherein the evaluation of the string of text is based on the compiler output.

19. The method of claim 18, further comprising:
interpreting the compiler output from the compiler based on a level of skill of a player of the video game to generate an interpretation of the compiler output, wherein the evaluation includes the interpretation of the compiler output.

20. A non-transitory computer readable storage medium having embodied thereon a program, wherein the program is executable by a processor to perform a method of content editing, the method comprising:
receiving a string of text through a user interface, wherein the user interface is part of a video game;
receiving context associated with the video game;
analyzing the string of text in light of the context to generate an evaluation of the string of text; and
outputting the evaluation of the string of text in the video game.
